(19) United States
(12) Patent Application Publication
(10) Pub. No.: US 2024/0359632 A1
(43) Pub. Date: Oct. 31, 2024

(54) VEHICLE HITCH MOUNTED CARGO BASKET

(71) Applicant: Pakmule, LLC, New Braunfels, TX (US)

(72) Inventor: Kansas SARTIN, New Braunfels, TX (US)

(73) Assignee: Pakmule, LLC, New Braunfels, TX (US)

(21) Appl. No.: 17/300,322

(22) Filed: Nov. 10, 2022

(51) Int. Cl. B60R 9/06

(52) U.S. Cl. CPC B60R 9/06

(57) ABSTRACT

Described herein is a vehicle hitch mounted cargo basket comprising a floor, one or more lips, a rim, a connector, and one or more reinforcing members.

### BACKGROUND

Many vehicles, in particular trucks, vans, and sport-utility vehicles (SUVs) come equipped with a hitch receiver. The hitch receiver is traditionally used to mount a tow ball to which a trailer may be connected.

In recent years, hitch receivers have been used to connect other mechanisms—such as bike racks and cargo storage baskets—to a vehicle. Cargo storage baskets in particular allow a vehicle operator to transport a small amount of cargo using their vehicle without the hassle, weight, and load balancing issues that come with towing a traditional trailer.

Existing cargo storage baskets are often heavy—making them difficult to install by a single operator. In addition, existing cargo storage baskets have limited options for attaching straps and other safety mechanisms used to hold cargo in place within the basket. They are also generally small, do not add sufficient additional cargo space, and—when loaded—prevent access to the rear cargo area of the vehicle. Additionally, they are often prone to wobbling.

The need exists, therefore, for an improved vehicle hitch mounted cargo basket which is lightweight, allows for sufficient options for attaching straps and other safety mechanisms used to hold cargo in place within the basket during operation, provide additional capacity and cargo access, and reduce or eliminate wobble.

### SUMMARY

Disclosed herein is a vehicle hitch mounted cargo basket. The vehicle hitch mounted cargo basket comprises a floor, at least one lip member, a rim, a connector, at least one reinforcing member, and a plurality of L brackets. The floor may have a floor first side, a floor second side opposite the floor first side, a floor first end extending between the floor first side and the floor second side, a floor second end opposite the floor first end, a top surface, and a bottom surface. The at least one lip member extends upwardly from the top surface. The rim is attached to a top edge of each lip member. The connector is attached to the bottom surface at or near a midpoint between the floor first end and the floor second end. The at least one reinforcing member is attached to the bottom surface of the floor. The plurality of L brackets are attached between at least one of the lip member and the connector. At least a portion of the connector extends past the floor second edge and is configured to mate with a vehicle hitch receiver.

In some embodiments, the vehicle hitch mounted cargo basket may further comprise one or more holes passing through the floor from the top surface through the bottom surface.

In some embodiments, the at least one lip member may comprise a first lip member, a second lip member, a third lip member, and a fourth lip member. The first lip member, when present, may extend upwardly from the top surface along at least a portion of the floor, first side. The second lip member, when present, may extend upwardly from the top surface along at least a portion of the floor second side. The third lip member, when present, may extend upwardly from the top surface along at least a portion of the floor third side. The fourth lip member, when present, may extend upwardly from the top surface along at least a portion of the floor fourth side.

In some embodiments, the at least one lip member may comprise at least one slot.

In some embodiments, the rim may have a substantially cylindrical cross sectional profile. In certain embodiments, the rim may have a shape and size which substantially conform to an exterior profile of the floor.

In some embodiments, the at least one reinforcing member comprises two reinforcing members connected to the bottom surface and extending between the floor first side and the floor second side.

In some embodiments, the vehicle hitch mounted cargo basket is comprised of a material which comprises aluminum.

### BRIEF DESCRIPTION OF FIGURES

FIG. 1 shows a perspective view of an embodiment of a vehicle hitch mounted cargo basket.

FIG. 2 shows a top view of the vehicle hitch mounted cargo basket of FIG. 1.

FIG. 3 shows a bottom view of the vehicle hitch mounted cargo basket of FIG. 1.

FIG. 4 shows a front view of the vehicle hitch mounted cargo basket of FIG. 1.

FIG. 5 shows a rear view of the vehicle hitch mounted cargo basket of FIG. 1.

FIG. 6 shows a right-side view of the vehicle hitch mounted cargo basket of FIG. 1.

FIG. 7 shows a left-side view of the vehicle hitch mounted cargo basket of FIG. 1.

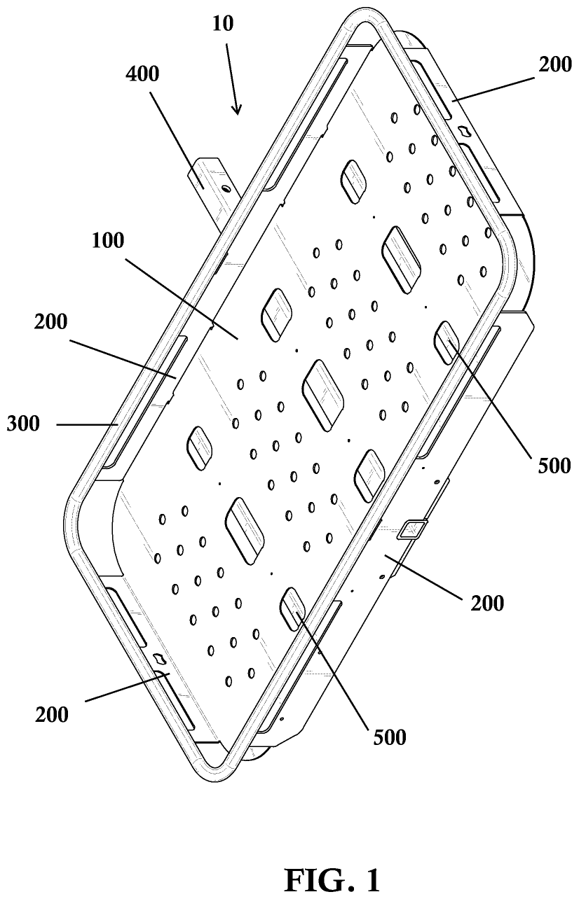

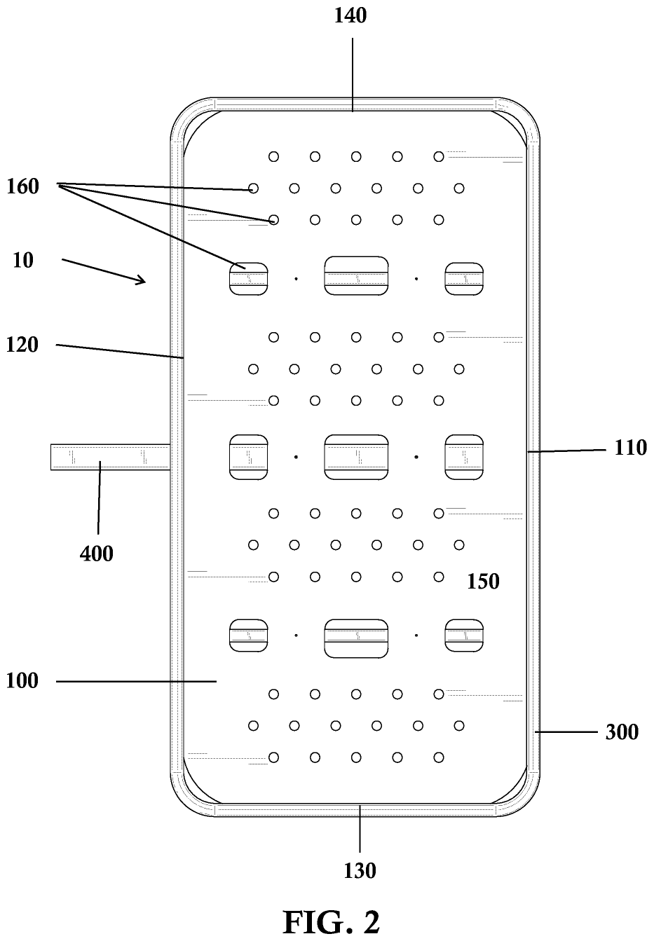

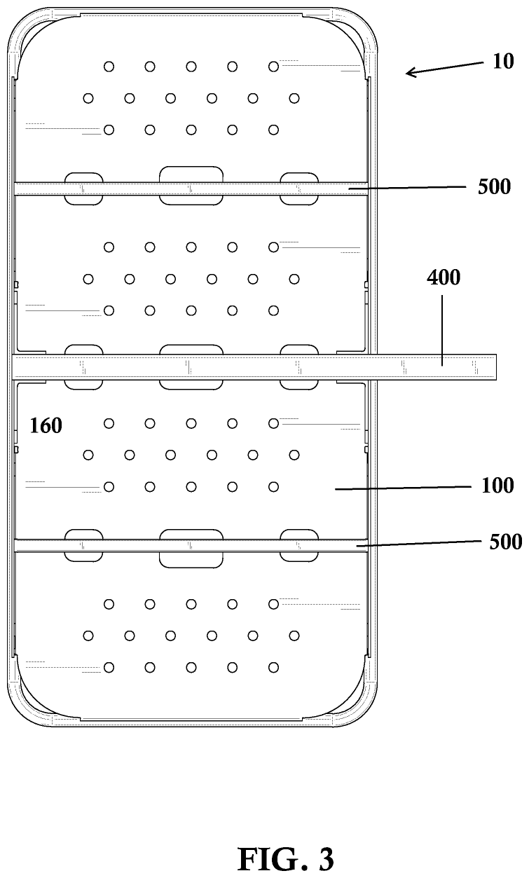

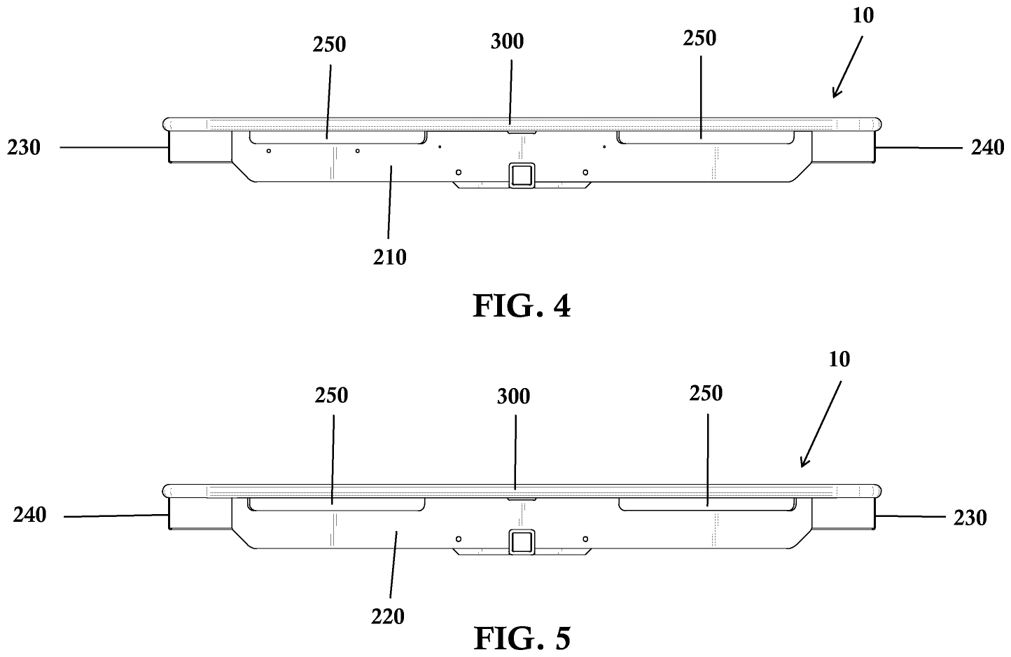

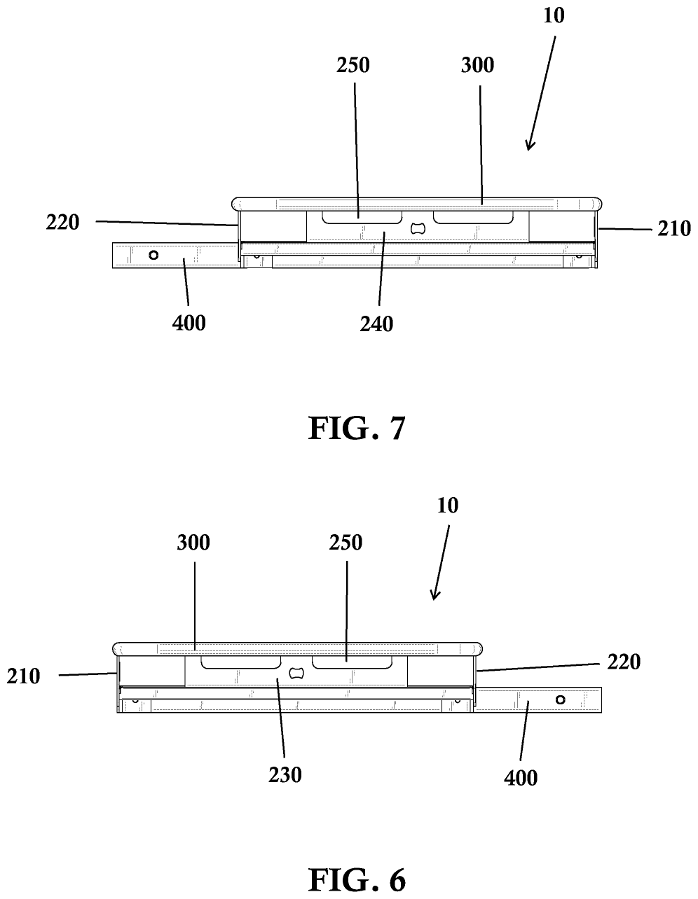

### DETAILED DESCRIPTION

Disclosed herein is a vehicle hitch mounted cargo basket. The vehicle hitch mounted cargo basket is described below with reference to the Figures. As described herein and in the claims, the following numbers refer to the following structures as noted in the Figures.
10 refers to a vehicle hitch mounted cargo basket.
100 refers to a floor.
110 refers to a floor first side.
120 refers to a floor second side.
130 refers to a floor first end.
140 refers to a floor second end.
150 refers to a top surface.
160 refers to a bottom surface.
170 refers to holes.
200 refers to lip members
210 refers to a first lip member
220 refers to a second lip member.
230 refers to a third lip member.
240 refers to a fourth lip member.
250 refers to slots.
300 refers to a rim.
400 refers to a connector.
500 refers to reinforcing members.
600 refers to an L bracket.

The Figures show one embodiment of a vehicle hitch mounted cargo basket (10). The vehicle hitch mounted cargo basket may comprise a floor (100), one or more lip members (200), a rim (300), a connector (400), one or more reinforcing members (500), and a plurality of L brackets as shown in the Figures.

The floor (100) may have any number of shapes including triangular, quadrilateral, ovular, circular, hexagonal, and the like. One preferred embodiment of the floor has a substantially rectangular shape as shown in the figures. In such embodiments, the floor will have a floor first side (110), a floor second side (120) opposite the floor first side, a floor first end (130) extending between the floor first side and the floor second side, and a floor second end (140) opposite the floor first end.

The floor will also have top surface (150) and a bottom surface (160). Passing through the floor from the top surface through the bottom surface may be one or more holes (170). The hole(s)—when present—may come in a variety of shapes and sizes. The holes allow for drainage of fluids—such as rainwater—from the cargo basket and may also serve as a mounting point to attach straps, carabiners, hooks, bolts, screws, tie-downs, bungee cords, and the like and other attachment mechanisms which assist in holding cargo in place inside the vehicle hitch mounted cargo basket. A fabric cover or tarp may also be securely fastened to the floor using such attachment mechanisms to cover and protect a load being carried in the vehicle hitch mounted cargo basket.

One or more lip members (200) extends upwardly from the top surface (150). In the embodiment shown in the figures there is a first lip member (210) extending upwardly from the top surface along at least a portion of the floor first side (110), a second lip member (220) extending upwardly from the top surface along at least a portion of the floor second side (120), a third lip member (230) extending upwardly from the top surface along at least a portion of the floor first end (130), and a fourth lip member (240) extending upwardly from the top surface along at least a portion of the floor second end (240). Each lip member may include one or more slots (250) which may serve as a mounting point to attach straps and other attachment mechanisms which assist in holding cargo in place inside the vehicle hitch mounted cargo basket.

Attached to a top edge of each of the lip members (200) may be a rim (300). The rim will typically have a substantially cylindrical cross sectional profile as shown in the Figures. Typically the rim will have a shape and size which substantially conforms to the exterior profile of the floor (100). That is to say that, when the floor has a substantially rectangular shape, the rim—will have a substantially rectangular shape of similar dimensions to the rectangular shape of the floor.

Attached to the bottom surface (160) of the floor (100) may be the connector (400) and one or more reinforcing members (500). Preferably the connector will be attached to the bottom surface at or near a midpoint between the floor first end (130) and the floor second end (140). The connector then extends past the floor second edge (120) and is configured to mate with a standard vehicle hitch receiver. One or more of the L brackets may be attached between at least one of the lip members—preferably the first lip member (210) and/or the second lip member (220)—and the connector.

The one or more reinforcing members (500) may be connected to the bottom surface (160) of the floor (100) in any number of locations. One embodiment shown in the figures includes two reinforcing members connected to the bottom surface and extending between the floor first side (110) and the floor second side (120).

The vehicle hitch mounted cargo basket may be made of any number of materials using any number of manufacturing techniques. The preferred material is aluminum as it is lightweight and durable. Other materials may include steel, thermoset materials, thermoplastic materials, fiber reinforced thermoplastic materials, and/or other lightweight, durable materials. The preferred manufacturing technique involves machining the various components of sheets or tubes of aluminum using waterjet, laser-cutting, or similar machines and welding the components together in the desired configuration. Other manufacturing techniques may include casting, 3D printing, machining from a piece of billet material, stamping, molding, extruding, pultruding, heat treating, bending, injection molding, and others.

The foregoing description of the exemplary embodiments has been provided for the purpose of illustration and description. It is not intended to be exhaustive or to limit the invention to the precise forms disclosed. Many modifications and variations will be apparent to practitioners skilled in the art. The embodiments were chosen and described to best explain the principles of the invention and its practical applications. It is intended that the scope of the invention be defined by the following claims and their equivalents.

1. (canceled)

2. A vehicle hitch mounted cargo basket (10), comprising:
a floor (100) having a floor first side (110), a floor second side (120) opposite the floor first side, a floor first end (130) extending between the floor first side and the floor second side, a floor second end (140) opposite the floor first end, a top surface (150), and a bottom surface (160);
at least one lip member (200) extending upwardly from the top surface;
a rim (300) attached to a top edge of each lip member;
a connector (400) attached to the bottom surface at or near a midpoint between the floor first end and the floor second end;
at least one reinforcing member (500) attached to the bottom surface of the floor; and
a plurality of L brackets (600) attached between at least one of the lip members and the connector; and
wherein at least a portion of the connector extends past the floor second edge and is configured to mate with a vehicle hitch receiver.

3. The vehicle hitch mounted cargo basket of claim 2, further comprising one or more holes (170) passing through the floor from the top surface through the bottom surface.

4. The vehicle hitch mounted cargo basket of claim 2, wherein the at least one lip member comprises:
a first lip member (210) extending upwardly from the top surface along at least a portion of the floor first side;
a second lip member (220) extending upwardly from the top surface along at least a portion of the floor second side;
a third lip member (230) extending upwardly from the top surface along at least a portion of the floor third side; and
a fourth lip member (240) extending upwardly from the top surface along at least a portion of the floor fourth side.

5. The vehicle hitch mounted cargo basket of claim 2, wherein the at least one lip member comprises at least one slot (250).

6. The vehicle hitch mounted cargo basket of claim 2, wherein the rim has a substantially cylindrical cross sectional profile.

7. The vehicle hitch mounted cargo basket of claim 2, wherein the rim has a shape and size which substantially conforms to an exterior profile of the floor.

8. The vehicle hitch mounted cargo basket of claim 2, wherein the at least one reinforcing member comprises two reinforcing members connected to the bottom surface and extending between the floor first side and the floor second side.

9. The vehicle hitch mounted cargo basket of claim 2, wherein the vehicle hitch mounted cargo basket is comprised of a material which comprises aluminum.

10. The vehicle hitch mounted cargo basket of claim 3, wherein the at least one lip member comprises:
a first lip member (210) extending upwardly from the top surface along at least a portion of the floor first side;
a second lip member (220) extending upwardly from the top surface along at least a portion of the floor second side;
a third lip member (230) extending upwardly from the top surface along at least a portion of the floor third side; and
a fourth lip member (240) extending upwardly from the top surface along at least a portion of the floor fourth side.

11. The vehicle hitch mounted cargo basket of claim 3, wherein the at least one lip member comprises at least one slot (250).

12. The vehicle hitch mounted cargo basket of claim 3, wherein the rim has a substantially cylindrical cross sectional profile.

13. The vehicle hitch mounted cargo basket of claim 3, wherein the rim has a shape and size which substantially conforms to an exterior profile of the floor.

14. The vehicle hitch mounted cargo basket of claim 4, wherein the at least one lip member comprises at least one slot (250).

15. The vehicle hitch mounted cargo basket of claim 4, wherein the rim has a substantially cylindrical cross sectional profile.

16. The vehicle hitch mounted cargo basket of claim 4, wherein the rim has a shape and size which substantially conforms to an exterior profile of the floor.

17. The vehicle hitch mounted cargo basket of claim 5, wherein the rim has a substantially cylindrical cross sectional profile.

18. The vehicle hitch mounted cargo basket of claim 5, wherein the rim has a shape and size which substantially conforms to an exterior profile of the floor.

19. The vehicle hitch mounted cargo basket of claim 6, wherein the rim has a shape and size which substantially conforms to an exterior profile of the floor.

20. The vehicle hitch mounted cargo basket of claim 10, wherein the at least one lip member comprises at least one slot (250).

21. The vehicle hitch mounted cargo basket of claim 20, wherein the rim has a substantially cylindrical cross sectional profile.
